(19) United States
(12) Patent Application Publication
(10) Pub. No.: US 2013/0291392 A1
(43) Pub. Date: Nov. 7, 2013

(54) MULTIPURPOSE INSTRUMENT FOR TRIANGLE SOLUTIONS, MEASUREMENTS AND GEOMETRICAL APPLICATIONS CALLED TRIOMETER

(71) Applicants: R.K. Swamy, Kota (IN); Alpha Swamy, Kota (IN); Beeta Swamy, Kota (IN); Gamma Swamy, Kota (IN); Delta Swamy, Kota (IN)

(72) Inventors: R.K. Swamy, Kota (IN); Alpha Swamy, Kota (IN); Beeta Swamy, Kota (IN); Gamma Swamy, Kota (IN); Delta Swamy, Kota (IN)

(21) Appl. No.: 13/980,318

(22) PCT Filed: Jan. 17, 2012
(86) PCT No.: PCT/IN12/00040

§ 371 Date: Jul. 18, 2013

(30) Foreign Application Priority Data
Jan. 18, 2011 (IN) 118/DEL/2011

(51) Int. Cl. G01B 3/00

(52) U.S. Cl. CPC G01B 3/002
USPC 33/415

(57) ABSTRACT

The invention “Trio-meter”is a multipurpose instrument by using—“Multi-slotted link sliding assembly mechanism”—for triangle solutions including Pythagoras theorem' as a ready reckoner (FIG. II). Useful instrument with marker block attachment to draw and measure straight lines, lengths, arcs, semi circles, circles, bicircles, tricircles, parallelograms, rhombuses, trapezoids, parallellines and triangles with fractional and accurate measurements easily and quickly (FIG. III to VIII). The novel instrument with tri-sector attachments, trisects an angle and multiplies an angle into double, triple & quadruple as well as reduces an angle in to two-third half, one third and quarter fractionally and accurately (FIG. IX). It comprises three slotted links with in built main measuring scales, which are also working as sides of a triangle, three vernier calipers with three protractors and three indicators, assembled by centre pins, with all necessary attachments, parts and components (1 to 99) for complete operations and perfect functioning.

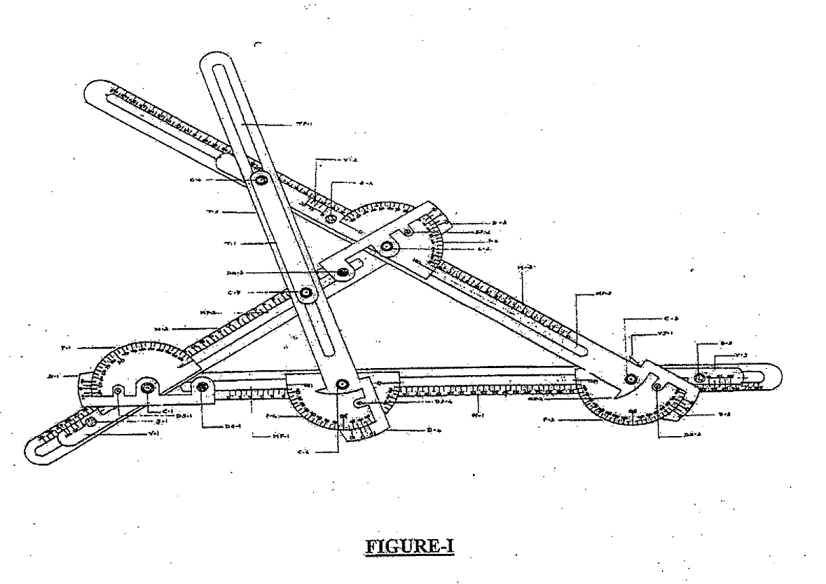

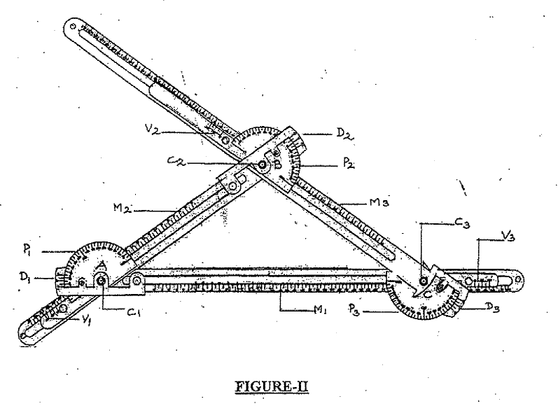

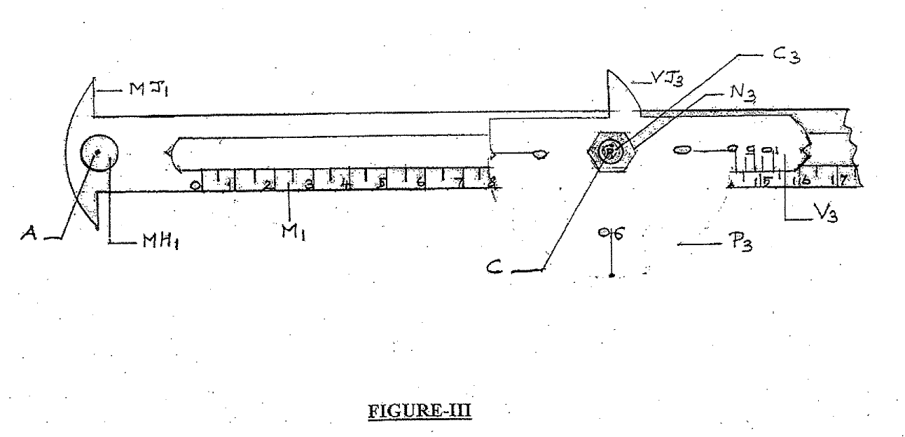

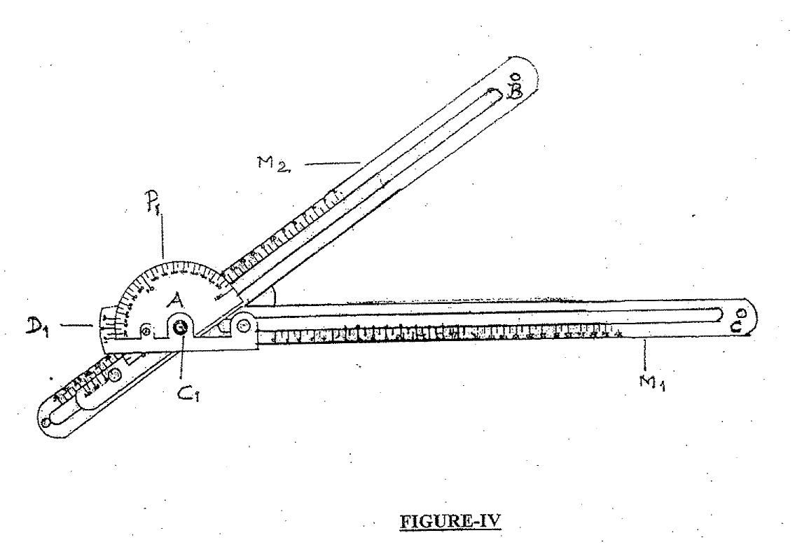

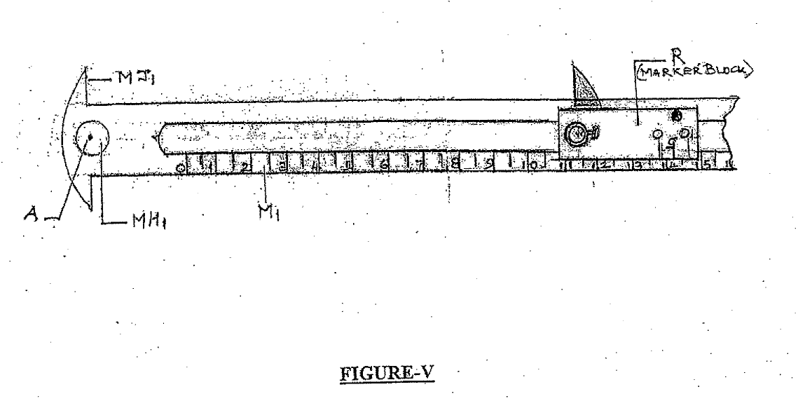

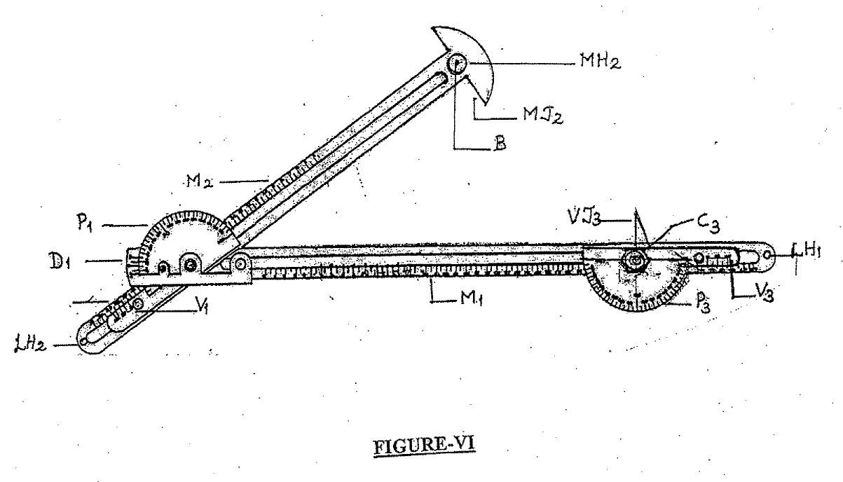

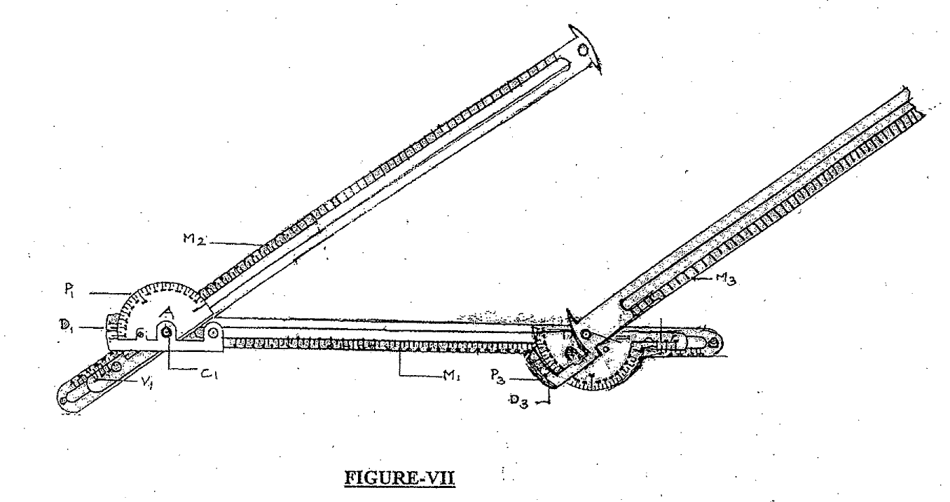

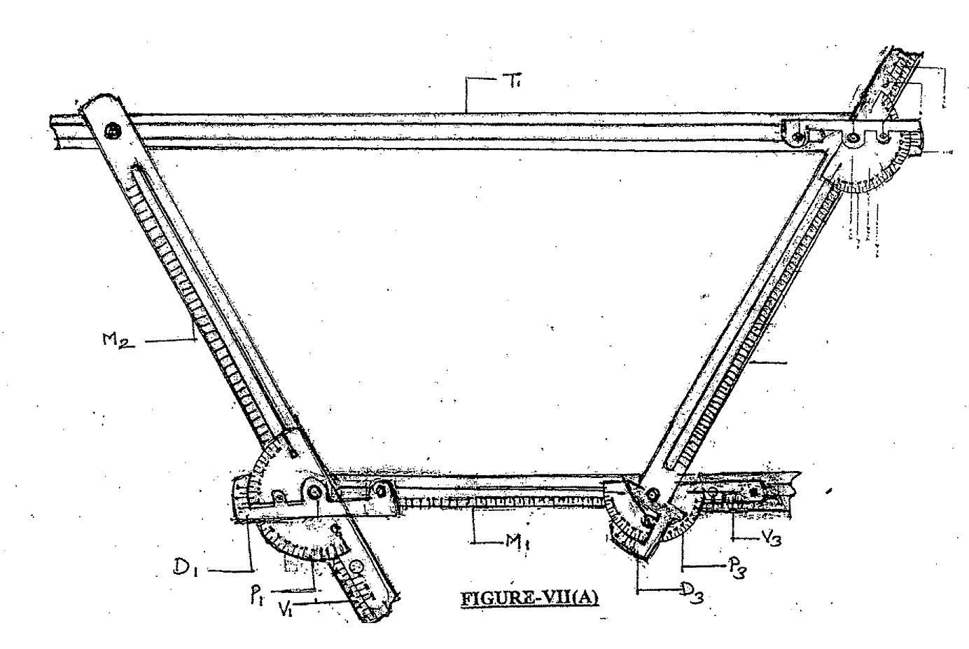

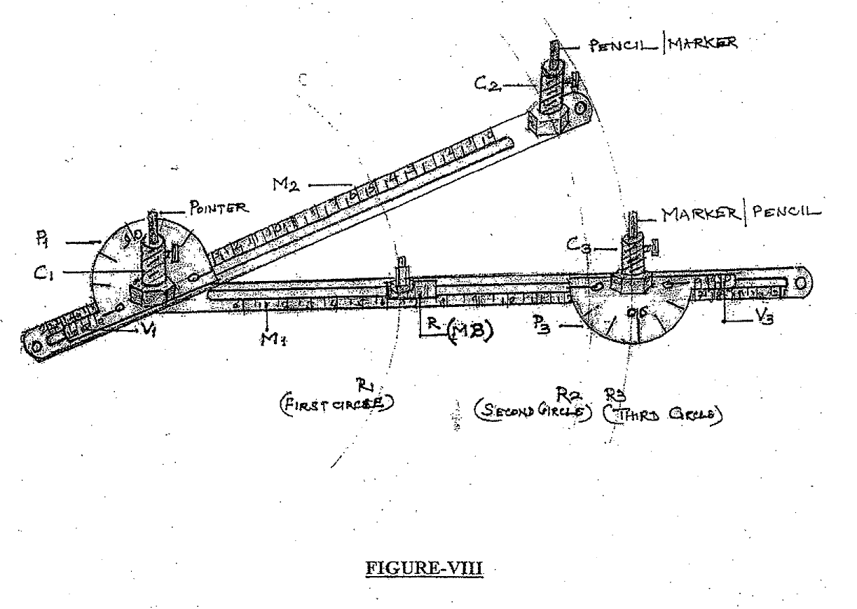

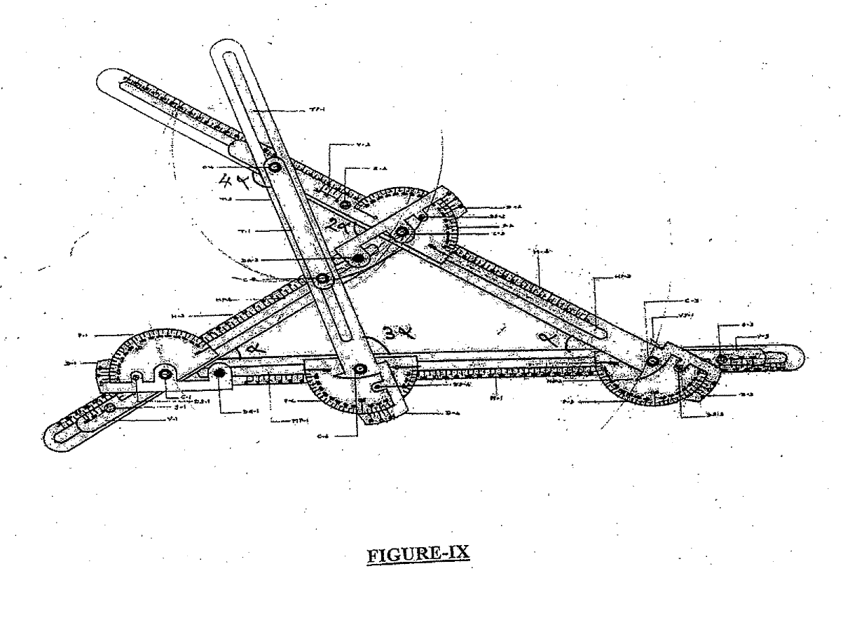

### FIELD OF INVENTION

The invention in general useful and relates to:

1. Mathematical solution of a triangle—Acute angled triangle, Right angled triangle, Obtuse angled triangle, Isosceles triangle, Equilateral triangle, Scalene triangle etc.—and including “Pythagoras” theorem, as a ready reckoner, quickly, easily and accurately,

2. Draw straight lines and lengths

3. Measure the lengths accurately by vernier caliper scale,

4. Draw angles as required by protractor with vernier divisions

5. Measure the degrees of angles accurately

6. Draw a triangle as required dimensions

7. Measure the size of a triangle with its sides & angles accurately

8. Measure the prism objects/materials with sides and angles,

9. Draw Parallelograms, Rhombuses and Trapezoids,

10. Measure the size of parallelograms, Rhombuses and Trapezoids with sides and angles accurately and fractionally,

11. Draw parallel lines,

12. Measure the distance between parallel lines

13. Draw arcs, semicircles, circles and concentric circles,

14. Draw bi-circles and tri-circles simultaneously with different radii accurately,

15. Measure the radius of circles,

16. Trisect and bisect an angle accurately and fractionally,

17. Reduce an angle into half, two-third, one-third and quarter,

18. Multiply an angle into double, triple and quadruple;

More particularly this invention relates to—Mathematical solutions of a triangle as a ready-reckoner Measurements by Vernier caller functions and Geometrical applications with drafter and compass operations as well as trisecting and multiplying of angles; accurately, quickly and easily,

by “Multi-slotted link sliding assembly mechanism” of slotted links with inbuilt measuring scale bodies comprises protractors and vernier calipers with necessary attachments and parts are assembled by centre pins is called “TRIO-METER”.

### BACKGROUND OF THE INVENTION

The fallowing description explains, various prior art technologies/methods and constrain in the methodology/technology. Present or existing system of solving the problems of triangles is the method of calculations only. Measuring lengths and accurate/fractional measurements, drawing lengths & geometrical applications, drawing triangles, trisecting & bisecting angles as well as multiplying and reducing angles, drawing and measuring parallelograms, rhombuses and trapezoids are by using scales, protractors, vernier calipers, drafters and compass etc separately and also with set of instruments.

Whether the student or engineer or architect or designer or teacher/professor or any other persons involved in education, teaching, research and civil constructions, engineering fabrications, structural engineering, wooden works, furnishing, plumbing, designing, drawing etc is still need to use the calculating method only for triangle and angle related solutions; in which lot of time is need to spend. A solution for Pythagoras theorem and solutions/properties like sides & angles of a triangle are takes sufficient time to find out.

This novel instrument named “Trio-meter” is a multipurpose tool; To solve many problems of a triangle, Drawing and measuring of triangles, angles, lengths, arcs, circles, bi-circles, tri-circles, parallelograms, rhombuses and trapezoids accurately, quickly and easily; multiply and reduce an angle as well as trisect/bisect an angle, as a single instrument. There is no such a mechanical instrument in the world with multi-functions, to find the sides & angles of a triangle as a ready reckoner and for complete vernier caliper functions as well as a trisector/bisector cum multiplier of an angle and also a parallelographer and a drafter with compass and other applications.

The existing methods are,

(1) Measuring of a side length with angles of a triangle needs scale or vernier caliper and protractor separately.

(2) Drawing lengths and angles are also now, by scales & protractors separately. For fractional and accurate measurements it needs further a vernier caliper scale also.

(3) For triangle related solutions; by knowing two sides & one angle or two angles & one side of a triangle or only knowing three sides of a triangle and then to find other remaining sides/angles there is a need to go through calculation systems only. This may be arithmetical or trigonometric system or any other mathematical calculation system; that surly takes sufficient time and mental strain.

(4) Drawing & measuring triangles are now needed to use scales, vernier calipers, protractors, drafter and compass etc.

(5) To trisect and divide an angle is now needed to use the protractor and compass. Likewise to multiply an angle is also by protractor and compass etc. But, there is no surety for perfect and accurate trisecting of an angle. For fractional and accurate measurements it needs to adopt a calculation system in trisecting of an angle.

(6) To draw parallel lines, now needed to use at least any two instruments like, two setsquares or T-square with set-square or any other set of instruments like these with protractor and scale or vernier caliper scale for accuracy.

(7) To draw arcs, semi-circles and circles, we need compass and scale or vernier caliper scale with measurement activities.

(8) To draw bi-circles, now needed to use compass, scale or vernier caliper two times in general, with measurement activity. Likewise for tri-circles, we need to use these instruments three times. Vernier caliper scale is needed further for fractional and accurate measurements.

(9) To draw Parallelograms, Rhombuses, Trapezoids etc. needed use a drafter, setsquares, protractors and vernier caliper scale separately. Even it is a difficulty to maintain fractional and accurate measurements of lengths and angles.

To avoid all types of strains and consumption of valuable time, the novel instrument Trio-meter replaces many types/methods of calculations for triangle solutions as well as using the scales, vernier calipers, protractors, compass, T-square, set-squares, drafter etc. separately for measurements and geometrical applications. There is no mechanical method or system existing to measure & find properties of a triangle as a ready-reckoner and also find the sides and angles accurately including trisecting and multiplying of an angle as well as to draw parallel lines, parallelograms, rhombuses, trapezoids and arcs, semi-circles, circles, bi-circles, tri-circles etc accurately and fractionally.

Hence, there is no exact prior art for this new instrument/invention. However, since new invention replaces all the present methods/systems of measurements by using scales, protractors, compasses, t-squares, set-squares, Vernier calipers and drafters separately as well as calculations by arithmetically, trigonometrically and other methods; the same are taken as the prior art for our new invention.

This novel instrument named “Triometer” is a multipurpose tool to solve many problems of various triangles, measuring lengths, angles and drawing arcs, circles, bi-circles, tri-circles, triangles as well as measuring triangles and multiply any angle as well as divide/trisect an angle, drawing parallelograms, measuring parallelograms as a single instrument. There is no such a mechanical instrument in the world to find the sides & angles of a triangle as a ready reckoner and a complete vernier caliper as well as a trisector/bisector cum multiplier of an angle, parallelographer and also a drafter with compass and other applications.

### OBJECT OF THE INVENTION

Millions of the people all over the world in the fields of education, industry, construction, design and research etc are using the old methods for solution of a triangle is, only by calculating arithmetical or trigonometric and other mathematical possibilities. Measuring and drawing the length of sides, angles between the sides and complete triangle by using various instruments, like scales, vernier calipers, protractors & compasses etc

To trisect and multiply any angle is also need protractor/compass and other instruments with measurement activities; sometimes it also needs vernier caliper attachments in the protractor for fractional and accurate measurements. To draw parallel lines also need at least a set of instruments. To draw bi-circles and tri-circles need to use compass and vernier caliper scale with measurement activities twice and trice.

The followers of these instruments and methods are experiencing lot of uncomfortable and consuming more time with difficulties to meet out their requirements especially the students, teachers, professors, engineers, architects, technocrats, designers, mathematicians, researchers, industrialists, entrepreneurs and other needy persons involved in civil constructions, engineering fabrications, wooden works etc are feeling more strain and laborious with waste of their valuable time through the existing methods/systems.

We, the inventors have realized the above said problems and indented to overcome the same and considered that, there must be a completely new mechanism should be invented and same could be applied for making such instruments. Then only the existing problems could be solved. According to this approach, we struggled in the past some years and finally conceived the novel idea “Triometer”, which is a mechanical instrument of multipurpose uses.

And by the application of Triometer, we have also invented a ready reckoner for triangle solutions, vernier caliper scale, compass, protractor with vernier divisions, angle trisector cum angle multiplier, drafter, parallellographer and such multi-functional instruments as a whole single one.

This is a successful attempt to convert a part of Mathematics—particularly, in the field of Geometry and Trigonometry—into Mechanical instrument for the practical uses of the students, technicians, mathematicians, teachers, professors, engineers, research scholars, designers, draftsmen, entrepreneurs, industrialists and other persons related with education, research, design, drawing, engineering and construction.

### STATEMENT OF THE INVENTION

The present invention relates to multipurpose instrument for many solutions of triangles, trisecting and bisecting angles, drawing tri-circles, bi-circles, angles, circles, parallel lines, parallelograms, rhombuses and trapezoids with fractional and accurate measurements. This novel instrument is to measure and draw the lengths by main scales and with vernier caliper scales accurately. All functions of vernier caliper scale for fractional and accurate measurements. Measure the degrees of angles accurately by protractors and indicators with vernier divisions. Measure the radius of circles with fractional and accurate measurements. A mathematical instrument for find the solutions of a triangle quickly, easily and accurately as a ready reckoner. Geometrical applications with drafter and compass functions to draw engineering and geometrical drawings. Drawing bi-circles and tri-circles with different radii and also measure the radii of various circles. Trisecting and bisecting an angle as well as reducing an angle into one-third, half, quarter and so on.

Multiplying an angle into double, triple and quadruple. Drawing arcs, semi-circles, circles, bi-circles, tri-circles, angles, triangles, parallelograms, rhombuses and trapezoids as required dimensions with fractional and accurate measurements, optionally along with

(1) Three slotted links with inbuilt measuring main scale bodies, working also as sides of a triangle unified by “multi-slotted link sliding assembly mechanism”.

(2) Three vernier calipers attached with protractors are used for accurate & fractional measurements of lengths and angles

(3) Three protractors are attached to measure the angles between two concerned slotted links/sides, by respective indicator accurately. One more additional protractor attached with tri-sector slotted link to indicate the angle that is multiplied triple or to be trisected.

(4) The indicators are attached with slotted links and center pins. All four indicators have vernier scale divisions to measure the degrees of angles accurately with minutes; which can be further modified to measure up to seconds also.

(5) One trisector link cum lever and a tri-sector slotted link are provided to trisect and bi-sect an angle as well as to multiply an angle into two, three & four folds.

(6) Three sliders are fixed in the bottom of the vernier calipers and one slider in the bottom of fourth protractor, are sliding in the respective slotted links and keeping protractors as well as vernier calipers in the correct and right position for operations.

(7) Three centre pins are provided to assemble and unify the novel instrument and also working as additional sliders. In addition to these three centre pins, three more centre pins are provided for trisector operations/applications. Hallow and cylindrical centre pins with marker holders used to insert marker/pointer/pencil for the functions of compass to draw arcs, circles, bi-circles, and tri-circles and locate the points etc.

(8) One Marker Block with hallow center pin to hold a marker/pointer/pencil for marking points and drawing lines in the middle of slotted paths. It has an attachment of vernier caliper scale with a jaw to measure the lengths and dimensions.

A method of manufacturing an instrument, to measure the lengths, angles & triangles and to solve the problems of a triangle as well as angle trisector cum angle multiplier, parallelographer and a drafter for geometrical and engineering drawings/designs for constructions, architecture, structural engineering, civil and many other industrial applications are as fallows;

Three slotted links are with inbuilt measuring scale body, working as main measuring scales and also as sides of a triangle for triangle related functions are slotted in the just middle of longitudinal made by metallic or plastic or any other material. It comprised with three vernier calipers and four protractors with sliders to measure the lengths & angles with higher accuracy. Protractor bodies are made by thin steel plate or any other strong material. The extended part of protractor body is vernier caliper scale. Locking knobs/nuts are provided with centre pins to fix the required lengths/dimensions are made by steel.

Two slotted links and two center pins are directly attached with indicator that moves/turns on protractors, so as to measure the degrees of angles between the links/sides accurately with fractional measurements. One trisector link cum lever with another trisector slotted link with indicator is made steel or any strong materials are used to trisect and multiply an angle accurately. This arrangement is further used to draw bi-circles, tri-circles, circles, semi-circles and arcs accurately and fractionally. Centre pins and knobs/nuts are made by metallic or plastic or any other material. The components of the novel instrument are precious and made by metallic or plastic or any other material for higher accuracy and better performance.

### BRIEF DESCRIPTION OF THE INVENTION

Figure I

Shows the fully assembled and exploded view of the novel instrument “multi-slotted link sliding assembly mechanism “Trio-meter” with parts.

Figure II

Shows the Triangle solutions with three main measuring scale cum slotted links—M1, M2 & M3 and P1, P2, P3, V1, V2 & V3 with sliders—S1, S2 & S3, centre pins—C1, C2 & C3, indicators-D1, D2 & D3 and marker block R with necessary components.

Figure III.

Shows the measurement arrangement with main measuring scale M1 & vernier caliper V3.

Figure IV

Shows the main measuring scales M1 & M2 and protractor P1 with indicator D1 for angles.

Figure V.

Shows the Marker Block—‘R’ and M1 for vernier caliper, compass and marker Applications.

Figure VI.

Shows the drafter, contains two slotted links M1 & M2 and protractors P1 & P3 with vernier V1 & V3

Figure VII.

Shows the parallelographer with three slotted links M1, M2 & M3 and protractors P1 & P3 with extended part V1 & V3.

Figure. VII (A)

Shows Parallelographer to draw Parallelograms, Rhombuses and Trapezoids. With slotted link ‘T1’, M1, M2, M3, V1, V2, V3 and centre pins C1, C2, C3 & C4.

Figure VIII.

Shows the compass functioning with slotted links M1 & M2, vernier calipers V1 & V3 with hallow centre pins C1, C2 & C3 and marker block ‘MB’

Figure. IX.

Shows the functioning of trisector cum angle multiplier with all main parts of the novel instrument.

### DETAILED DESCRIPTION OF THE INVENTION

The fallowing specification particularly, describes the nature of the invention and the manner in which, it is to be performed.

The present invention relates to a multipurpose instrument for triangle solutions including ‘Pythagoras theorem’ as a ready reckoner and relates to angles, triangles, circles, parallelograms, vernier caliper functions, geometrical applications with drafter and compass operations/applications, as well as angle trisector cum angle multiplier and for various fractional and accurate measurements—using “multi-slotted link sliding assembly mechanism”called Trio-meter, Comprises,

(A) Three slotted links with inbuilt main measuring scales (1) M1, (2) M2 and (3) M3 are attached with jaws (4) MJ1, (5) MJ2 & (6) MJ3 respectively on both sides at zero measurement portion (in the beginning of the links). Centre hole (7) MH1, (8) MH2 & (9) MH3 is provided in each main measuring scale slotted link at zero measurement point.

(B) Four semi-circle protractors (10) P1, (11) P2, (12) P3 & (13) P4 are marked with zero to 180 degree equal divisions, clockwise, as well as anti-clockwise directions and with centre hole (14) PH1, (15) PH2, (16) PH3 & (17) PH4.

(C) Four indicators (18) D1, (19) D2, (20) D3 & (21) D4 are to measure the degrees of angles accurately. The indicators D1 & D2 are attached with centre pins C1 & C2 to measure the angles in the protractors P1 & P2 respectively. The indicators D3 & D4 are attached directly with M3 & T2 as an extended part to measure the degrees of angles in the protractor P3 & P4 respectively

(D) Three vernier calipers (22) V1, (23) V2 & (24) V3 are attached and fixed with the extended part of protractor bodies P1, P2 & P3—are useful for accurate and fractional measurements. Vernier caliper body V3 is further extended for the attachment of trisector links T1 & T2 with a centre hole ‘TH4’ in which centre pin ‘C4’ to be inserted.

(E) Vernier caliper jaws (25) VJ1, (26) VJ2 and (27) VJ3 are attached with protractor bodies of P1, P2 and P3—at the centre of each protractor—to serve the purpose of vernier caliper functions.

(F) Three sliders (28) S1, (29) S2 & (30) S3 are fixed in the bottom of the vernier calipers V1, V2 & V3 respectively and the fourth slider (31) S4 is provided under P4; which are sliding in the slotted links M2, M3 & M1 with concerned protractor and vernier caliper respectively.

(G) Three centre pins (32) C1, (33) C2 & (34) C3 threaded in the top portion with locking knobs/nuts (38) N1, (39) N2 and (40) N3 are to unify and assemble the novel instrument as well as serve the purpose of slider also. Three more centre pins (35) C4, (36) C5 & (37) C6 are for trisector links T1 & T2 along with locking knobs (41) N4, (42) N6 & (43) N6.

(H) Three vernier caliper locking screws (44) VS1, (45) VS2 & (46) VS3 are provided in the vernier caliper threaded holes (47) VH1, (48) VH2 & (49) VH3 to lock the vernier caliper movements as well as to fix the required measurements in M1, M2 & M3 with locking.

(I) Four indicator locking screws (50) DS1, (51)DS2, (52) DS-3 & (53) DS4 are in the indicator's threaded holes (54) DH1, (55) DH2, (56) DH3 & (57) DH4 to lock the movement of indicator as well as to fix the measurement of angles in the protractors P1, P2, P3 & P4 respectively.

(J) Marker Block (58) ‘R’ has multiple function with vernier caliper including vernier jaw, one plate strip at centre with downward direction (working as also a jaw) and a centre pin with holder attachment to hold the marker/pen/pencil/pointer to mark the lines, points, spots etc as per need. It helps to mark the lines/points in the centre of the slotted links. It also helpful for vernier caliper functions.

(K) Trisector link cum. lever 59 T1 with center pin hole (60) TH1 & (61) TH2 and Trisector slotted link (62) with centre pin hole (63) TH3, are provided with centre pins C4, C5 & C6 to trisect and multiply an angle. Trisector link T1 is fitted in the centre pins C4 & C5 and Trisector slotted link T2 with indicator D4 is fitted in the centre pins C4, CS & C6 for the purpose of trisector operations.

(L) Slotted paths, (64) SP1, (65) SP2, (66) SP3 & (67) SP4 are in the just middle of slotted links M1, M2, M3 & T2 and leg holes (68) LH1 (69) LH2, (70) LH3 & (71) LH4 are in the end of the slotted links with stands/legs (72) L1, (73) L2, (74) L3 & (75) L4 respectively.

(M) Two pairs of Plotter holes (76) PL1 & (77) PL2 and (78) PL3 & (79) PL4 are provided in both sides of the slotted link M2. Two pairs of Plotter holes (80) PL5 & (81) PL6 and (82) PL7 & (83) PL8 are provided in both sides of the slotted link M3. One pair of Plotter Pin set (84) PP1 & (85) PP2 and (86) PP3 & (87) PP 4 is provided for M2 & M3 respectively for the purpose of trisector operations.

(N) The cylindrical and hallow center pins, with threaded holes in the sides of head portion (88) CH1, (89) CH2, (90) CH3, (91) CH4, (92) CH5 & (93) CH6 and holder screws (94) CSI, (95) CS2, (96) CS3, (97) CS4, (98) CS5 & (99) CS6, to hold the marker/pointer/pencil and other objects inserted in the hallow portion of centre pins,

By “Multi slotted link sliding assembly mechanism”.

In still another embodiment of the present invention slotted links M1, M2 & M3 are straight & plain plates made by metallic or plastic or any other material. It is slotted just middle in the longitudinal direction of the plate, keeping sufficient spaces on both sides of slotted path in which main measuring scales are inbuilt.

In still another embodiment of the present invention the slotted links M1, M2 & M3 are also working, as sides (AC, AB, BC) of a triangle, when this novel instrument is used for triangle related solutions/functions. (FIG. II)

In still another embodiment of the present invention on the side of sliding path, main measuring scale divisions are marked in centimeters & millimeters system. If needed inch (FPS) system can be adopted on one of the sides of sliding path.

In still another embodiment of the present invention slotted paths SP1, SP2, SP3 & SP4 of M1, M2, M3 & T2 respectively are with a width equal to the diameter of slider and centre pin for smooth sliding.

In still another embodiment of the present invention the slotted link M1, M2 & M3 has a centre pin hole MH1, MH2 & MH3 at beginning (zero measurement point) and leg hole LH1, LH2 & LH3 at the end of link respectively. The diameter of the centre pin hole and leg hole is equal to the diameter of centre pin. The trisector slotted link T2 also has a centre hole TH-2 at the portion of indicator attachment and the leg hole LH-4 at the end.

In still another embodiment of the present invention each slotted link plate M1 M2 & M3 has attached with jaw MJ1, MJ2 & MJ3- respectively from both sides with sufficient length at zero measurement part, in horizontal. In M3, it is further extended with an attachment of indicator D3. These jaws are useful for vernier caliper functioning and geometrical applications. As per requirements these jaws can be extended in vertical or also can be removed.

In still another embodiment of the present invention the slotted path starts away from real zero measurement point for smooth sliding and techno feasibility. The measuring scale marked according to the zero starting point of the sliding. Hence, the vernier caliper scale's zero measurement is also starts with the same distance, from zero or the centre of protractor and vernier caliper jaw. In other words the distance between MJ and zero of main measuring scale is equal to the distance of VJ and zero of vernier scale.

In still another embodiment of the present invention the protractors P1, P2, P3 & P4 are semi-circle in shape made by metallic or plastic or any other material in which 0-180 degree-equal divisions are-marked in clockwise and also anti-clockwise directions, to measure the angle from both sides. The protractor is divided into 180 equal parts. These protractors can be made and designed to measure 360 degrees with complete circle body if needed or as per design of the novel instrument.

In still another embodiment of the present invention the protractors P1, P2 & P3 are semi-circle body extended and attached with vernier caliper scale. It has been assembled upon main measuring scale cum slotted links M2, M3 & M1 respectively. Where as protractor P4 has no extension and fitted upon the main measuring scale M1 and below T2 for trisector related functioning.

In still another embodiment of the present invention the each & every protractor plate has a center pin hole PH1, PH2, PH3 & PH4 at center of diagonal (centre of the circle), through which the . centre pin passes to assemble the novel instrument. The diameter of the hole is equal to the outer diameter of centre pin.

In still another embodiment of the present invention the protractors P1, P2 & P3 are attached with vernier jaw VJ1, VJ2 & VJ3 at zero measurement points ‘A’, ‘B’ & ‘C’ respectively for the purposes of vernier caliper functions and geometrical applications. It can be removed as per need.

In still another embodiment of the present invention the indicator D1, D2, D3 & D4 has vernier scale divisions 0-10, which coincides with 9 (nine) main parts/divisions of protractor to measure the angles accurately up to 0.1 degree or 6 minutes (6′=0.1 degree) which can be further modified & developed to measure up to the accuracy of seconds of a degree also or as per design and need. In still another embodiment of the present invention the each indicator arm's measuring portion—on which vernier scale divisions are marked—is a curved part with a radius equal to the radius of protractor body for the purpose of Perfect & accurate measurement of an angle.

In still another embodiment of the present invention the indicator D1 & D2 are fixed with centre pins C1 & C2 respectively. C1 is fixed with M1 and C2 is fixed with M2. So, the movement of D1 is directly depends upon/with M1 & C1. Likewise the movement of D2 is with M2 & C2. When Ml turns with C1, the D1 also turns on protractor P1. In the same manner D2 turns on protractor P2, when M2 turns with C2.

In still another embodiment of the present invention the indicator D3 is an attached part of slotted link M3 and lying upon protractor P3 to measure the angles easily. Likewise indicator D4 is an attached part of trisector slotted link T2, which lying upon protractor P4 to measure the angles during trisector linked operations.

In still another embodiment of the present invention the indicator D1 & D2 is made by metallic or plastic or any other material with a curved portion of vernier divisions and centre pin hole DH1 & DH2 respectively. The indicators are made in different designs as per need and techno, feasibility of the instrument.

In still another embodiment of the present invention the indicator D1 & D2 are designed in various models according to the need of the novel instrument. Measuring part of each model is curved with a radius equal to the radius of protractor body.

In still another embodiment of the present invention locking screws DS1, DS2, DS3 & DS4 are provided in each indicator arm's threaded hole DH1, DH2, DH3 & DH4 respectively to lock the movement of indicator with required measurement/angle and without stopping the sliding movement of protractors/verniers.

In still another embodiment of the present invention the vernier caliper V1, V2 & V3 (attached with protractor body as an extended part) are moving with sliders and protractors. The sliders are fixed in the bottom of each vernier caliper and sliding in the respective slotted paths. V3 is further extended for the purpose of trisector operations and it has a centre pin hole ‘TH4’ at point ‘D’ for centre pin C4. The distance between the holes of PH3 & TH4 is noted as ‘BD’. This distance can be changed according to the design or as per need.

In still another embodiment of the present invention vernier caliper is made by metallic or plastic or any other material (vernier and protractor body is same) has 20 (twenty) vernier scale divisions; which coincides with 19 (nineteen) main scale divisions. Hence the accuracy of measurement up to 0.05 mm is ensured. Vernier scale divisions can be increased or decreased as per need of the accuracy or according to the design.

In still another embodiment of the present invention the Marker block ‘R’ is provided to mark the points and lines. It has a hallow center pin with a holder in which marker/pointer is provided. It is attached with a vernier caliper scale and marker jaw. Slider is fixed under vernier caliper scale plate to move in the slotted links. The diameter of slider as well as center pin is equal to other center pins.

In still another embodiment of the present invention the trisector link cum lever T1, has two centre pin hole TH1 & TH2 in each edge with a diameter equal to the outer diameter of centre pin. The distance between TH1 & TH2 is equal to the distance between PH3 & TH3. Trisector link T1 is inserted in the centre pins C4 & C5 by its holes TH1 & TH2 at points ‘D’ and ‘E’ respectively. The distance between TH1 & TH2 is noted as ‘DE’, which is equal to ‘BD’. (BD=DE).

In still another embodiment of the present invention trisector slotted link 12, has slotted in the just middle in longitudinal. It is attached in one end with indicator D4, is made by metallic or plastic or any other material. It has central pin hole TH3, where indicator D4 is attached and it has a leg hole EH4 at the end of the slotted link.

In still another embodiment of the present invention distance of “D” from ‘B’ is fixed as equal to half-length of ‘AB’ or ‘BC’. AB & BC is fixed with a distance of double length of ‘BD’, for trisector operations as per geometrical laws. The lengths of ‘AB’ & ‘BC’ are fixed with equal length and according to this length, the length of ‘CD’ & ‘DE’ is fixed and decided as half-length of ‘AB’ or ‘BC’.

In still another embodiment of the present invention, for the purpose of trisector operations, centre pin CS is fixed at ‘E’ in the slotted link ‘M2’. For this, the trisector link ‘T1’ is provided with centre pin holes TH1 & TH2 (with a distance equal to ‘BD’ which is to be inserted in the centre pins C4 & C5. So, BD=DE=1/2AB=1/2BC for trisector related operations.

In still another embodiment of the present invention for the purpose of trisector operations, trisector link ‘T1’ is provided and fixed upon slotted trisector link T2 to keep the centre pins C4 & C5 at a decided distance. Which is half-length of ‘AB’ or “BC”. Both the centre pins are also working as sliders in T2. Slotted trisector link T2 is sliding in C4 & C5 and making movements/sliding of slotted links M2 & M3; that forms the angle BAC & angle BCA at points ‘A’ & ‘C’. Hence the angle EFC is trisected. The trisector link cum lever T1 can also be fitted under T2. The main purpose of T1 is to keep and maintain the distance between ‘D’ & ‘E’, which is equal to ‘BD’.

In still another embodiment of the present invention for the purposes to solve the solutions of a triangle, three slotted links cum main measuring scales M1, M2 & M3 with three protractors P1, P2 & P3 and the vernier caliper scales V1; V2 & V3 are assembled by centre pins C1, C2 & C3 with necessary components. This arrangement itself an explainer; this forms a triangle with sides and vertices.

Let, the triangle is “ABC”. Then, side AB is the length between C1 & C2; Side ‘BC’ is the length between C2 & C3 and side ‘AC’ is equal to the length of distance between C1 & C3. The vertices of triangle ‘ABC’ are represents at C1, C2 & C3 noted as ‘A’, ‘B’ & ‘C’ respectively. This arrangement of three sides and three angles of a triangle; it is easy to find un-known angles/sides quickly and accurately, by setting the known sides/angles. It means by knowing, any two sides and any one angle or any two angles and any one of the sides-the remaining one side and two angles or remaining one angle and two sides can be find out easily, quickly and accurately.

In still another embodiment of the present invention for the purposes to solve the solutions of “Pythagoras Theorem” the novel instrument is arranged with M1, M2 & M3, protractors P1, P2 & P3 with indicators and vernier caliper scales V1, V2 & V3 assembled by center pins C1, C2 & C3 and necessary components. The angle ‘A’ (angle BAC) is set with 90* by protractor P1; that is right-angled triangle. Any one of the known sides, either ‘AB’ or ‘AC’ or ‘BC’ is to be fixed by V1/V2/V3. Likewise any one of the remaining angles ‘B’ or ‘C’ is to be fixed by protractor P2/P3. This set-up of the novel instrument is a ready reckoner to, find the remaining two sides and one angle easily, quickly and accurately. Likewise by knowing any two sides of any right angled triangle, it is possible to find the third side and two angles very easily, quickly and accurately.

In still another embodiment of the present invention the centre pins C1, C2, C3, C4, C5 & C6 are hallow and cylindrical in shape. Hallow cylindrical pins are provided to insert a marker/pointer/pencil for marking and other needs as required. These center pins are made by metallic or plastic or any other material have fallowing details; particularly

(1) Centre pins C1 & C2 are with circular base fitted from the bottom of slotted links of M1 & M2 and passes through its centre pin holes MH1 & MH2 respectively at points ‘A’ & ‘B’. Indicators D1 & D2 are fitted with C1 & C2 respectively, in the head. Centre pin C3 is at ‘C’. Where as C4, C5 & C6 are provided and fitted at ‘D’, ‘E’ & ‘F’ respectively, with trisector links.

(2) The centre pins are cylindrical in shape with an outer diameter equal to the diameter of centre pin holes of protractor PH1, PH2, PH3 & PH4 and holes of slotted link MH1, MH2 & MH3 and TH1 TH2, TH3 & TH4 as well as equal to the width of slotted path.

(3) The middle portion (above base) of centre pin is provided to insert the slotted links, protractor, indicator etc and remaining upper part of the pin has threaded head.

(4) Upper part of the pin has a diameter of middle part with threaded head and attached with locking knobs/nuts N1, N2, N3, N4, N5 and N6, respectively in C1, C2, C3, C4, C5 & C6. Washers are used as per need.

(5) In the upper side part of each hallow cylindrical centre pin, threaded hole CH1, CH2, CH3, CH4, CH5 & CH6 is provided with a screw CS1, CS2, CS3, CS4, CS5 & CS6 respectively to hold a pointer/pencil/marker or any other sharp edged material which is to be inserted (if needed) in the hallow part of the centre pin for the purposes of geometrical applications and compass functions etc. These screws are also helpful to fit necessary parts in the center pins.

In, still another embodiment of the present invention centre pin C1 is fixed at ‘A’ in the bottom of M1, passes through the centre pin holes of
MH1 of slotted link (main measuring scale) M1,
Through slotted path SP2 of link M2,
PH1 of protractor P1 and DH1 of indicator D1.

In still another embodiment of the present invention centre pin C2 is fixed at point ‘B’ in the bottom of M2 passes through
>The centre pin hole of MJ 2 of slotted link M2,
>The slotted path SP3 of link M3,
>PH2 of protractor P2 and centre pin hole DH2 of indicator D2.

In still another embodiment of the present invention centre pin C3, is fixed at point ‘C’ passes through
>The slotted path SP1 of link M1.
>The centre hole PH3 of protractor P3 and
>MH3 of slotted link & main Measuring scale M3.

In still another embodiment of the present invention the centre pin C4, is fixed at point ‘D’ passes
>Through slotted path SP3 of M3
>Through TH4 of V2,
>Slotted path SP4 of trisector slotted link T2 And
>TH1 of trisector lever T1.

In still another embodiment of the present invention the centre pin C5; this is fixed at point ‘E’ passes
>Through slotted path SP2 of link M2,
>Slotted path SP4 of trisector link T2 and
>Canter pin hole TH2 of T1.

In still another embodiment of the present invention centre pin C6, is fixed at point ‘F’ passes through
>Slotted path SP1 of M1,
>Centre pin hole PH4 of protractor P4,
>Centre pin hole TH3 of trisector slotted link T2.

In still another embodiment of the present invention the Marker Block ‘MB’ is an extra set of attachment with sliding block, vernier caliper scale, centre pin and marker with all other necessary components to draw straight lines and mark the points in the centre of slotted paths. It is also useful to measure the lengths accurately by vernier caliper attachments.

In still another embodiment of the present invention the centre pin C1 is fitted with slotted link M1 in the centre hole MH1 from bottom at point ‘A’. In this centre pin C1, main-measuring scale cum slotted link M2 is inserted through its sliding path (upon MD. Protractor P1 is fitted through its centre hole PH1 upon the slotted link M2. The indicator DI is fitted on P1 and the locking nut N1 is provided to assemble all these parts. Necessary washers are also used as per need and for techno feasibility.

In still another embodiment of the present invention the centre pin C2 is fitted with M2 from the bottom through its centre hole MH2 at point ‘B’. In this centre pin C2, M3 is inserted through its slotted path upon M2 and P2 is fitted by PH2 in C2 upon M3. Locking nut N2 is fitted to assemble all these parts. Necessary washers are also used as per need and for techno feasibility.

In still another embodiment of the present invention the centre pin C3 is fixed at point ‘C’. At this point in the centre pin C3, slotted link Ml is inserted through its sliding path. Protractor P3 is fitted upon link M1. Slotted link M3 with its extended part indicator D3 is inserted through its centre hole MH3 upon P3. Locking nut N3 is used to unify and assemble all these parts. Necessary washers are also used as per need and for techno feasibility.

In still another embodiment of the present invention centre pin C1 is unifying the parts of this novel instrument P1, M1 with indicator D1 and V1 & VJ1 (both are extended parts of P1). It is one of the three main centres/junctions to operate the instrument including for triangle/trisector related functions and this centre notified as point ‘A’.

In still another embodiment of the present invention centre pin C2 is unifying the parts of this novel instrument P2, M2 with indicator D2 and V2 & VJ2 (both are extended parts of P2). So, it is one of the three main centres/junctions to operate the instrument for triangle & trisector related functions and this center have been notified as point ‘B’.

In still another embodiment of the present invention centre pin C3 is unifying the parts of this novel instrument P3, M3 with indicator D3 and V3 & VJ3 (extended parts of P3). So, it is one of the three main centres/junctions to operate the instrument for triangle/trisector related functions and this centre notified as point ‘C’.

In still another embodiment of the present invention centre pin C4 is fitted at point ‘D’ and unifying M3, V2, T1 & T2 for trisector functions. Point ‘D’ is one of the main centres to operate the trisector related functions. Whereas trisector link cum lever T1 has inserted in centre pin C4 through its centre hole TH1 to keep the distance between ‘D’ & ‘E’ intact. When T1 turns at point ‘B’, it makes the movements at points, ‘A’, ‘B’, ‘C’, ‘E’ & ‘F’. According to those movements the angles in these points are also forms as per geometrical laws. C4 is working as a slider in the slotted links SP3 & SP4.

In still another embodiment of the present invention centre pin C5 is at point ‘E’, where slotted links M2 & T2 are intersecting each other with T1, during the operations. In the centre pin C5, slotted path SP2 of M2, slotted path SP4 of trisector link T2 and centre hole TH2 of T1 is inserted for trisector functions. The centre pin C5 is working as slider in both the slotted links M2 & T2.

In still another embodiment of the present invention centre pin C6 is a junction pin at point ‘F’ where trisector link ‘T2’ is fitted upon slotted link M1. C6 is working also as a slider in the slotted link M1, for the function of trisecting and multiplying of an angle. Trisector slotted link T2 is fitted here through its centre pin hole TH3. Protractor P4 is inserted in the centre pin C6, between M1 & T2 to measure the angle ‘EFC’ at ‘F’.

In still another embodiment of the present invention the turning of trisector link T1 at point ‘D’ directly makes the movement of slotted link M3 at ‘C’. M3 is fitted with M2 at ‘B’. So, M2 also moves according to M3. These movements making various angles as per geometrical laws, at points ‘A’, ‘B’, ‘C’, ‘D’, ‘E’ & ‘F’; which helps the operations to bi-sect, trisect and quarter the angle as well as makes double, triple and quadruple of the angle. The lengths of links are fixed as

The lengths of ‘AB’ and ‘BC’ are equal to double length of ‘BD’ or ‘DE’.

AB=BC and BD=DE & BD=DE=½ AB=½ BC

By which the fallowing triangles are forming in the instrument: ABC, CDF, BDE & AEF

In the triangle ‘ABC’ Side ‘AB’=side ‘BC’. . . so, Angle ‘BAC’=angle ‘BCA’=α=angle ‘EAF’ Hence, angle ‘ABD’=α2α=angle ‘EBD’

In triangle ‘BDE’ Side ‘AB’=side ‘DE’ Hence, angle ‘DBE’=angle ‘DEB’=2α=angle ‘AEF’ So, angle ‘EFC’=‘AEF’+‘EAF’=3α

Likewise angle ‘EDG’=‘EBD’+‘DEF’=4α Or ‘EDG’=‘EFC’+‘FCD’=4α

In still another embodiment of the present invention the novel instrument for Trisector functioning can also arranged in the plotter holes of the links, specially made for this purposes. The first pair of plotter holes PL1 & PL2 are provided in the slotted link M2 at point ‘A’ and the second pair of plotter holes PL3 & PL4 are provided in the slotted link M2 at point ‘E’ where the T1 is fixed by C5 and trisector slotted link T2 intersects with M2. The third pair of plotter holes PL5 & PL6 are provided in the slotted link M3 at point ‘B’ and the fourth pair of plotter holes PL7 & PL8 are provided in the slotted link M3 at point ‘D’ where T1 fixed by C4.

In still another embodiment of the present invention the Plotter Pin set has two pins, fixed in the lower sides of a plain plate. The plain plate has a center hole at middle to insert a center pin, with a diameter equal to center pin. The plotter pin has a diameter equal to the diameter of plotter hole. The pair of pins are inserted in the pair of plotter holes directly and fixed with help of respective center pins. The center pins are also keeping plotter pin sets in proper plotter hole pairs and assembling the related links.

In still another embodiment of the present invention the distance between pairs of plotter holes in M2 & M3 are made as per geometrical laws. The plotter holes are made in the slotted links to assemble in such a way to keep all links as follows:

AB=BC and

BD=DE=½ BC This arrangement in the novel instrument also makes the formation of fallowing triangles: ABC, CDF, BDE & AEF

In the triangle ‘ABC’ Side ‘AB’=‘BC’. . . so, Angle ‘BAC’=angle ‘BCA’=α=angle ‘EAF’ Hence, angle ‘ABD’=2α=angle ‘EBD’

In triangle ‘BDE’ Side ‘BD’=side ‘DE’ Hence, angle ‘DBE’=angle ‘DEB’=2α=angle ‘AEF’ So angle ‘EFC’=‘AEF’+‘EAF’=3α

Likewise angle ‘EDG’=‘EBD’+‘DEF’=4α Or ‘EDG’=‘EFC’+‘FCD’=4α

In still another embodiment of the present invention the locking knob/nut N1 is fitted in the threaded head of centre pin C1 to assemble the parts of the instrument P1 with VI & VJ1, M1 as well as M2. It helps to stop/lock the movement of indicator D1 with M1, P1 with V1 and M2 at point ‘A’. It is to fix the required measurements in both slotted link M2 and protractor P1.

In still another embodiment of the present invention the locking knob/nut N2 is fitted in the threaded head of centre pin C2 to assemble the parts of the instrument P2 with V2 & VJ2; M2 as well as M3.it helps to stop/lock the movement of M2, protractor P2 with V2. It is to fix the required measurements in the slotted link M3.

In still another embodiment of the present invention the locking knob/nut N3 is fitted in the threaded head of centre pin C3 to assemble the parts of the instrument P3 with V3 & VJ3, M3 with D3 and M1. It helps to stop/lock the movement of D3 with M3, P3 with V3. It is also to fix the required measurements in the protractor P3 and in the slotted link M1. Hence, the locking knobs/nuts are helpful to lock both movements of indicator and vernier caliper with slider simultaneously.

In still another embodiment of the present invention the locking knobs/nuts N4, N5 & N6 are provided with C4, C5 & C6 at points ‘D’, ‘E’ & ‘F’ respectively for trisector related functions. These nuts/knobs are made by metallic or plastic or any other material.

In still another embodiment of the present invention the indicator locking screw DS1, DS2 DS3 & DS4 is provided upon each indicator's threaded hole DFH1, DH2, DH3 & DH4 respectively to lock the movement of the indicator as well as fix the angle in the protractor. By locking the indicator the movement of vernier and protractor with slider is get free for sliding in the concerned slotted link.

In still another embodiment of the present invention the vernier locker screw VS1, VS2 & VS3 is provided on each vernier caliper's threaded hole VH1, VH2 & VH3 respectively to stop/lock the movement of vernier caliper and fix the measurement/length in the main scale. By locking vernier caliper with protractor, the movement of indicator is free to turn on the protractor.

In still another embodiment of the present invention the slotted links ‘M1’ with hallow cylindrical centre pins ‘C1’ & ‘C3’ and vernier caliper ‘V3’ is used for the functioning of compass. A sharp pointer or marker at zero measurement point ‘A’ is being inserted and a pencil/marker in ‘C3’ is fixed by ‘CS3’. To draw arcs, semi-circles and circles, fix a radius in the main scale ‘M1’ and vernier caliper ‘V3’. By keeping point ‘A’ as a centre and turning the point or marker/pencil inserted in ‘C3’ (fig. VI) to draw arcs/semi-circles/circles as per need.

In still another embodiment of the present invention two compasses/two markers are arranged to draw bi-circles simultaneously with different radii. Compass pointer is fixed in C1. Markers are fixed in C2 and C3. Pointer at ‘A’ is assumed as the centre of a circle and markers in C2 & C3 are adjusted to fix the radii of first and second circle by using main scales & vernier calipers M1, M2 and V1 & V2 respectively, for accurate and fractional measurements. This arrangement in the novel instrument (fig. VIII.) is to draw bi-circles smoothly as well as to draw many numbers of circles.

In still another embodiment of the present invention three compasses/three markers are arranged to draw tri-circles with different radii simultaneously. Main measuring scales cum slotted links M1 & M2 with vernier calipers V1 & V2 are fixed with required radii. And marker block-‘R’ is also fixed either in M1 or M2 with required radius. The pointer/markers are fitted in the hallow part of all three centre pins—C1, C2 & C3 with the help of holder screws CS1, CS2 & CS3 respectively. Marker block ‘R’ is also ready with marker. This arrangement—keeping C1 (A) where pointer is fixed, as center of a circle—in the novel instrument) to draw tri-circles smoothly as well as to draw many numbers of tricircles as required (fig. VIII).

In still another embodiment of the present invention the leg holes LH1, LH2, LH3 & LH4 are provided in the end corner of slotted links M1, M2, M3 & T2 to fix the stands/legs L1, L2, L3 & L4 respectively; so as to maintain the plane level and techno feasibility of the novel instrument during operations, on the table/surface. These points (centre of holes) are noted as ‘G’, ‘H’, ‘I’ & ‘J’.

(The invention is described in the following pages and the salient feature of the instrument is described fully and completely.)

Functioning of the Instrument

The functioning of the novel instrument is as follows:—

Function. I

Ref. Figure.II

Mathematical instrument to the solutions of a triangle as a ready reckoner.

The novel instrument triometer is only a mechanical tool to solve many solutions/problems of a triangle/particularly mathematical solutions of a triangle—Acute angled triangle, Right angled triangle, Obtuse angled triangle, Isosceles triangle, Equilateral triangle, Scalene triangle etc.—and including “Pythagoras” theorem, as a ready reckoner, quickly, easily and accurately, As per figure No.II, Instrument itself in a triangle shape and self-explainer one.

The functioning of novel instrument triometer for solutions of a triangle and ‘Pythagoras’ theorem as follows:—

Unify all three main measuring scales (slotted links) M1, M2 & M3 with all three protractors P1, P2 & P3 with vernirer caliper scales V1, V2 & V3 and sliders S1, S2 & S3 by centre pins C1, C2 & C3 and with other necessary components.

STEP.1.

First take the slotted link M1 and fix it in the centre pin C1 through its centre pin hole MH1. Insert the slotted path SP2 of M2 in the centre pin C1 upon M1; Fix protractor P1 and its attached parts vernier caliper V1 with slider S1 in the centre pin C1 up on M2. Pit washer and locking nut N1 in C1. Now, fix the indicator D1 in C1, by using side screw CS1.

STEP.2

Fix the centre pin C2 in MH2 of slotted link M2 from bottom. Insert slotted path SP3 of measuring main scale M3 in the centre pin C2. Use locking nut N2 with washer in C2, upon protractor P2. Fix the indicator D2 in the centre pin C2 by side screw CS2.

STEP.3

Insert centre pin C3 in the slotted path SP1 of main measuring scale M1 at anywhere. Fix the protractor P3 with vernier V3 and slider S3 in the centre pin C3. Insert slotted link cum main measuring scale M3, through its center pin hole MH3 in C3 and fix locking nut N3 in the centre pin C3.

Now the novel instrument is ready for operations and functioning as a ready reckoner to the solutions of a triangle (See Figure II). The centers/points of C1, C2 & C3 are noted as ‘A’, & ‘C’ respectively and let the sides of triangle ABC are ‘AB’, ‘BC’ & ‘AC’

STEP. 4

(I). By knowing two sides AB & BC and one angle BCA, of triangle ‘ABC’ and need to find third side ‘AC’ and remaining two angles CAB & ABC; fix the length/side AB in M2 by using vernier caliper V1 at ‘A’ and fix the length of BC in the main measuring scale M3, by using the vernier caliper V2 accurately. Then fix angle BCA, in the protractor P3 by using indicator D3 and lock the instrument at ‘A’, ‘B’ & ‘C’ by tightening the knobs/nuts N1, N2 & N3 in the pins C1, C2 & C3. Now the novel instrument Triometer will automatically show the length of remaining side BC and the angles CAB & ABC accurately.

By knowing any two angles (let it be angles ABC & BCA and one side AC of triangle ABC; it is easy to find the remaining third angle and two sides very quickly and accurately without delay and strain, fallowing the above method. First fix the length of the known side AC, in the main scale M1 by using V3 for accurate length. Then fix the angle ABC at ‘B’ by using protractor P2 & indicator D2. In the same way using P3 & D3 fix the angle BCA at ‘C’ and lock/tight the center pins C1 & C2 by using N1 & N2. Now, measurements of the sides AB & BC and angle BAC will be find automatically at points ‘B’, ‘C’ & ‘A’ respectively.

(III). By knowing all three sides of a triangle—AB, BC & AC only and need to find all three angles; first fix all the sides as above method by using V1, V2 & V3 and lock/tight the instrument by using N1, N2 & N3. Now can read and find all three angles BAC, ABC & BCA accurately available in the protractors P1, P2 & P3 respectively.

Likewise it solves many problems of a triangle-very easily, very quickly, very accurately and also without any strain by knowing only.—Two sides & One angle or Two angles & One side or Three sides of any triangle.

STEP.5

Pythagoras Theorem related solutions:—The sides of triangle BC & AC and the right angle BCA are available. Now, there is a need to find the side AB and the angles ABC and BAC. For this purpose, with above arrangement first set up the Right angle BCA at ‘C’ in the protractor P3 by using D3 and lock it by DS3. Set the side length AC in the main measuring scale M1 by using vernier caliper scale V3 and lock it by VS3. Then set the side length BC in the main measuring scale M3 by using V2 and lock it by VS2. Now, the novel instrument is ready to provide the side length AB and the angles ABC & BAC.

Likewise in any Right angled triangle, the solutions can be get easily, quickly and without strain by knowing only—one side & one angle or two sides of a triangle.

Function.2

Ref. Figure.III Drawing and measuring of lengths & straight lines. Take the slotted link MI and fix vernier caliper scale V3 with VJ3 by using center pin C3 & N3 to draw straight lines and lengths. Using pencil/marker/pointer draw straight line/lines of any length starting from zero measurement point ‘A’ at main jaw M1 of M1 and up to vernier jaw VJ3. The length between MJ1 & VJ3 can be adjusted or fixed by using the main scale of M1 and vernier scale V3. It is a major benefit of the novel instrument that a line can be draw with accuracy and up to fraction of millimeter. With this arrangement we can measure the length of any line/lines also accurately up to fraction of millimeter.

The length/dimension of any object/material

(Ref. Figure.III) The length/dimension of any object can also be measured by this system. To do this exercise the main measuring scale cum slotted link M1 be used. Take the object and keep it between both jaws MJ1 & VJ3. Lock the movement of vernier V3 by using VS3. Now measurement can be taken in the main scale M1, where the zero division of the vernier scale points with main scale division; it indicates the measurement of centimeter and millimeter. Further to get the fraction of millimeter, note the vernier scale division, which is coincides perfectly with the main scale division and then calculate to achieve the accurate measurement. Likewise length of any object can also be calculated easily—by keeping the length between MS1 & VJ3.

Function.3

Ref. Figure.IV

Drawing and measuring angles Take main measuring scales M1 & M3 and protractor P3 with center pin C3 & N3. Insert center pin C3 anywhere in the slotted path-MP I of main scale M1 and insert P3 & M3 in C3; Then use N3 to keep all parts in proper manner.

Set/fix the required angle in the protractor P3 by using M3 & D3 and lock the setup by N3. Now, draw the said angle between M1 & M3 accurately up to fraction of degree. With these parts of set up, the novel instrument can be used to measure an angle up to the fraction of degrees.

Keep the object/material between the two slotted links, M1 & M3. Lock the indicator D3 (extended part of M3) by N3. Now measure the degrees of angle in the protractor P3, where zero division of indicator D3 points. For accurate and fractional measurement find the vernier division of the indicator, which coincides with the main, scale division of the protractor and calculate as follows:—

(We know that 9 divisions of protractor coincide with 10 divisions of vernier scale of the indicator. So, the accuracy can be measured up to 1/10 degree=0.1 degree=6 minutes of degree.) Assume that zero division of indicator pointing between 36 & 37 degree of protractor and 9th vernier scale division coincides with a division of main scale. Then the Angle=36+(9×6)=36 degrees 54 minutes.

Function.4

Ref. Figure. V Marker Block MB-‘R’

The Marker Block-‘R’ is an important multipurpose attachment for marking the points, drawing lines in the center of slotted paths, measuring lengths accurately with vernier caliper functioning and also can be used in the Trisector applications.

It comprises hallow center pin with locking nut, vernier caliper scale plate with locking screw & slider and marker/pointer/pencil with necessary components.

It can be used in any slotted path of main measuring scales as well as in Trisector link's slotted path to mark the lines/points.

The Marker Block is easy to attach in the slotted path; by inserting its center pin in the slotted path and then vernier caliper plate in the center pin upon main measuring scale. Use locking nut to assemble Marker Block. Now it will slide in the slotted path and can mark a line in the middle of slotted path by a marker, which has been inserted in the center pin.

Function.5

Ref. Figure. VI

Drafter for Geometrical Drawings. Take main measuring scales M1 & M2, vernier calipers V1 & V3 with protractor P1 & P3 and center pins C1 & C3 with N1 & N3 etc. Assemble M1, P1 & M2 at point ‘A’ by using C1 & N1. Insert C3 in MP1 and fix P3 with V3 in C3 by using N3. Now, the instrument is ready to draw lines and angles as needed.

To draw perpendiculars

Take two slotted links with two vernier caliper attachments; particularly, M1 & M3 with V2 & V3 (attached with P2 & P3) and center pins C2 & C3. Indicator D3 is attached with M3 as an extended part.

Take M1 with C3. Insert the slotted path of M1 in C3 at anywhere from zero measurement point. Insert P3 with V3 and S3 in the centre pin C3 upon M1 and slotted link M3 with indicator D3 on P3. By using the locking nut N3 keep the inserted parts in proper place/manner. Then insert the centre pin C2 (after removing from M2) in the slotted path of M3 at anywhere from zero measurement point. Then insert P2 with V2 in. C2 upon M3. By using locking nut N2 keep all inserted parts in proper way.

Fix Right Angle—90 degrees—in the protractor P3 by using indicator D3 and lock it by locking screw DS3. Fix the height of perpendicular in measuring scale M3 accurately by using V2 and lock it by VS2.

Now, the novel, instrument is ready to draw perpendiculars as required. Draw base line in the slotted path SP1 by using Marker Block and perpendiculars in the slotted path SP3 of M3.

Function.6

Ref. Figure. VII Parallelographer to draw parallel lines

Take M1, M2 & M3, P1 & P3 with V1 & V3, C1 &. C3 with N1 & N3 and Marker Block. ‘R’. Assemble the parts at points ‘A’ & ‘C’ using C1 & C3 and N1 & N3. Now, with this arrangement the novel instrument is ready to draw Parallel lines. Set/fix the required angle of the parallel lines at ‘C’ between MI and M3, by using P3 & D3 and lock the movement of D3 by using DS3. Keep MI stable as basic line and draw parallel lines by moving/sliding V3 with P3 as required, using Marker Block. Fix the same angle between M1 & M2 by using P1 & D1. Lock the movement of D1 by DS1. Now the novel instrument is ready to draw parallelograms. Using marker block With this instrument parallel lines can be drawn accurately with an angle of fraction of degree. The distances between parallel lines can be changed as per need, very quickly and very easily with higher accuracy without changing the main setup and only by sliding.

Ref. Figure. VII (A)

Parallelographer to draw Parallelograms etc. Attach one more slotted link ‘T1’ with centre pin C4. Insert in C4 in T1 through its hole TH1 and then M2 through its hole MH2 upon T1. Assemble T1 & M2 by N4. Insert the slotted path of T1 & M3 and P3 with V3. Assemble these parts by N2. Now the novel instrument is ready to draw

Parallelograms, Rhombuses and Trapezoids. Take the dimensions of a parallelogram and set it in the novel instrument. Fix one of the two sides of a parallelogram in the main scale MI by adjusting V3, accurately and then lock V3. In the same manner fix/set another side of the parallelogram in the main scale M2 by adjusting vernier caliper V1 and then lock V1 by locking screw VS1. Likewise set the angles of parallelogram by using P3 & D3 accurately at ‘C’ and another angle by using P1 & DI at ‘A’. After fixing two sides and two angles, fix the length of third side between C3 & C4 (CD) in the main measuring scale M3, equal to the length of ‘AB’ by using ‘V2’ and then use VS2 to lock V2.

Now, complete formation of parallelogram is available in the novel instrument for drawing. By using marker block, draw parallelogram/parallelograms through marking the straight lines in the slotted paths and joint all corners of parallelogram. The major benefit of this novel instrument is that the sides with lengths and angles can be drawn up to fractional measurement with higher accuracy.

The same setup of the novel instrument is very much useful to measure any parallelogram with sides and angles accurately up to fraction of millimeter and degree, very quickly and very easily with higher accuracy. Likewise the Rhombuses and Trapezoids can be drawn by this setup of the novel instrument.

Function.7

Compass for Circles and other Geometrical applications

(Ref. Figure. VIII) For compass, take following parts of the novel instrument Trio-meter; Main measuring scales M1 & M2, Centre pins C1, C2 & C3 with locking nuts and side screws, Vernier caliper V1 with P1 & S1 and vernier V3 with P3 & S3, Marker Block ‘MB’, One, pointer and two pencils/markers Arrange and fix the above parts of novel instrument in the respective places. Keep the pencils/markers in the centre pins C2 & C3 (these centres are noted as points ‘B’ & ‘C’) and fix it by using side screws CS2 & CS3 respectively. Insert a pointer in C1 (this centre is noted as ‘A’) lock it by CS1. Now the instrument is ready to use as a compass. Fix the radius ‘AC’, of any arc/semi-circle/circle in the main scale MI and by using vernier V3 accurately with fractional measurement. Keep and press the pointer at ‘A’ (as a centre of a circle) and turn the centre ‘C’ so as to draw the arc/semi-circle/circle by the pencil/marker fixed in C3. (For more comfortable drawing of single circle the slotted link M2 is to be removed.) This novel instrument is further applied to draw bi-circles of different radii, with slotted link M2 & centre pin C2. Fix another radius ‘AB’ in the main scale M2 and accurately up to fractional measurement by using vernier V1. Lock the vernier caliper V1 by VS1. Keep and press the pointer at ‘A’ (as a centre of a circle) and turn both slotted links M1 & M2. Which are drawing bi-circles by the pencils/markers (inserted & fixed in the centre pins C2 & C3). This novel instrument is useful to draw two circles or concentric circles simultaneously with different radius very quickly, very easily and with higher accuracy.

This novel instrument is further applied to draw tri-circles of different radii. For this purpose fix the marker block ‘MB’ in M1. Fix the radius of third circle AR by adjusting vernier caliper of marker block and lock it. Now, from center of a circle ‘A’ three different radii—‘AB’, ‘AC’ & ‘AR’-circles-Tri circles—can be drawn easily, quickly and accurately by turning M1 & M2.

This novel instrument is also applied to measure the radius of any circle/semi-circle/arc.

Function. 8

(Ref. Figure. IX)

Functioning of trisector and multiplier of an angle. The complete instrument as shown in the figure I, with Marker Block is for the purposes of Tri-sector related functioning. The novel instrument with all parts including additional attachments of slotted link ‘T1’, trisector lever ‘T2’, protractor F4 and center pins C4, C5 & C6 with locking nuts N4, N5 & N6 are used for trisecting and multiplying of an angle. This is based on geometrical laws. In this novel instrument, the turning of trisector link T1 at point ‘D’ directly makes the movement of slotted link M3 at ‘C’. M3 is fitted with M2 at ‘B’. So, M2 also moves according to M3. These movements making various angles as per geometrical laws, at points ‘A’, ‘B’, ‘C’, ‘D’, ‘E’ & ‘F’; which helps the operations to bi-sect, trisect and quarter the angle as well as makes double, triple and quadruple of the angle. The lengths of links are fixed as fallows. Fix the lengths of ‘AB’ and ‘BC’ as same and equal to double length of ‘BD’ or ‘DE’.

AB=BC & BD=DE

BD=DE=½ AB=½ ABC

By which the fallowing triangles ABC, CDF, BDE & AEF is forming in the instrument. In the triangle ‘ABC’ Side ‘AB’=side ‘BC’ . . . so, Angle ‘BAC’=angle ‘BCA’=α=angle ‘EAF’ Hence, angle ‘ABD’=2α≈angle ‘EBD’

In triangle ‘BDE’ Side ‘BD’=side ‘DE’ Hence, angle ‘DBE’=angle ‘DEB’=2α=angle ‘AEF’ So, angle ‘EFC’=‘AEF’+‘EAF’=3α

Likewise angle ‘EDG’=‘EBD’+‘DEF’=4α Or ‘EDG’=‘EFC’+‘FCD’=4α

It explains the function of“Multiplier of an Angle”. Angle BCA doubles at ‘B’ & ‘E’ ie. Angles DBE & DEB respectively. And triples at ‘F’ as angle EFC and quadruples at ‘D’ as angle EDG. angle EDO.

With this arrangement of the instrument to Trisect an angle, the fallowing steps to be taken. By turning T1 & T2 fix the angle EFC (which is to be trisected) at F in the protractor P4 accurately, using D4 and lock it by DS4. Now, find the trisector slotted link & trisector lever has been automatically turned by above arrangement and will shown the ⅓ of angle EFC at points ‘A’ & ‘B’.

The angle BAC angle BCA=⅓ angle EFC The turning of T1 & T2 makes the movement of M1 & M2 directly and it sets the angles BAC & BCA at points ‘A’ & ‘C’ respectively. The fallowing geometrical law acts behind this formation. Length of AB=BC. So, in the triangle ABC, angle formed at ‘A’ is equal to the angle at ‘C’. ie. angle BAC=angle BCA

Length of BD=DE. So, in the triangle BED, angle formed at ‘B’ is equal to the angle at ‘E’ ie angle BED=angle DBE=⅔ angle EFC Angle DBE=angle AEF (Lines AB & DF intersects at ‘E’.) So, angle AEF=⅔ angle EFC.

This function is very easy, very quick, very accurate and without any strain. Even those who are unable to understand the mathematical/geometrical laws, also operate the instrument easily without any trouble.

### SUMMARY OF INVENTION

Millions of the people all over the world in the fields of education, industry, construction, design and research etc are using the old methods for solution of a triangle; that is only by calculating arithmetic or trigonometric and other mathematical systems. These methods and systems take lot of time and mental as well as physical strain.

Trisect of an angle and reducing/multiplying an angle up to fractional and accurate measurements of degree also an exercise in the existing methods and systems and also takes sufficient time as well as mental strain.

Reducing of an angle up to 180 degrees in to two-third; half, one-third and quarter simultaneously and multiplying an angle up to 180 degrees in to two-third, half, one-third and quarter simultaneously, as well as both functions of reducing and multiplying of an angle is also a hardship by existing methods and systems with available instruments.

Drawing bi-circles and tri-circles simultaneously with fractional and accurate measurements is difficult and time-consuming work in the existing systems.

Doing all the above exercises by a single instrument easily, very quickly and without any mental and physical strain was a need of the time; for which the inventors came with this invention of multi-purpose novel instrument “Trio-meter”. It is only such a single instrument, replaces all the old and different existing methods/systems, is very useful to modem era to easy the industrial, commercial and other process by saving lot of time.

The invention/novel instrument is a multipurpose instrument by using ‘multi-slotted link sliding assembly mechanism’ called “Trio-meter” is only a mechanical instrument in the world to solve the solutions of a triangle as a ready reckoner including the Pythagoras theorem.

The novel instrument is useful to draw triangles, angles, bi-angles, arcs, semicircles, circles, bi-circles, tri-circles, parallelograms, rhombuses, trapezoids, lengths and straight lines with fractional and accurate measurements easily and very quickly.

The novel tool “Trio-meter” is very useful to measure the triangles, angles, bi-angles, arcs, semicircles, circles, bi-circles, tri-circles, parallelograms, rhombuses, trapezoids, lengths and straight lines with fractional and accurate measurements easily and very quickly with out any strain.

The multi-purpose and multi-functional novel instrument with slotted links of in built main measuring scales, protractors and vernier calipers as well as necessary attachments/parts are very easy to operate even by low educated persons.

1-63. (canceled)

64. The novel instrument by “Multi-slotted link sliding assembly mechanism”—called ‘Trio-meter’ is a multi-purpose instrument for,
Mathematical solutions of a triangle—for Acute angled triangle, Right angled triangle, Obtuse angled triangle, Isosceles triangle, Equilateral triangle and Scalene triangle—as a ready reckoner;
Solve the “Pythagoras” theorem as a ready reckoner;
Draw straight lines and lengths; Measurements of lengths fractionally and accurately;
Draw angles as required fractionally and accurately; Measure the degrees of angles fractionally and accurately;
Draw a triangle as required dimensions; Measure the size of a triangle with its sides & angles accurately;
Draw Parallelograms, Rhombuses and Trapezoids; Measure the size of parallelograms, Rhombuses and Trapezoids with sides and angles accurately and fractionally;
Draw parallel lines; Measure the distance between parallel lines and angles of parallel lines,
Draw arcs, semicircles, circles and concentric circles;
Draw bi-circles and tri-circles simultaneously with different radii accurately;
Measure the radius of an arc and a circle;
Trisect an angle accurately and fractionally;
Reduce an angle fractionally and accurately into half, two-third, one third, and quarter (one forth) simultaneously,
Multiply an angle into double, triple and quadruple fractionally and accurately simultaneously,
Said instrument comprises,
(A) Three slotted links with inbuilt main measuring scales (1)M1, (2)M2 and (3)M3 are attached with jaws (4)MJ1, (5) MJ2 & (6)MJ3 respectively on both sides at zero measurement portion (in the beginning of the links). Centre hole (7)MH1, (8)MH2 & (9)MH3 is provided in each main measuring scale cum slotted link respectively at zero measurement point.
(B) Four semi-circle protractors (10)P1, (11) P2, (12) P3 & (13) P4 are marked with zero to 180 degree equal divisions, clockwise as well as anti-clockwise directions and with centre hole (14)PH1, (15)PH2, (16)PH3 &(17)PH4 respectively.
(C) Four indicators (18)D1, (19)D2, (20)D3 & (21) D4 are to measure the degrees of angles accurately. The indicators D1 & D2 are attached with centre pins C1 &C2 to measure the angles in the protractors P1 & P2 respectively. The indicators D3 & D4 are attached directly with M3 & T2 as an extended part to measure the degrees of angles in the protractor P3 & P4 respectively.
(D) Three vernier calipers (22)V1, (23)V2 & (24)V3 are attached and fixed with the extended part of protractor bodies P1, P2 & P3 respectively, are useful for accurate and fractional measurements. Vernier caliper body V3 is further extended for the functions of trisector attachment.
(E) Vernier caliper jaws (25)VJ1, (26) VJ2 and (27) VJ3 are attached with protractor bodies of P1, P2 and P3 respectively—at the centre of each protractor—to serve the purpose of vernier caliper functions.
(F) Three sliders (28)S1, (29)S2 & (30)S3 are fixed in the bottom of the vernier calipers V1, V2 & V3 respectively and the fourth slider (31)S4 is provided under P4; which are sliding in the slotted links M2, M3 & M1 with concerned protractor and vernier caliper respectively.
(G) Three centre pins (32)C1, (33)C2 & (34)C3 threaded in the top portion with locking knobs/nuts (38) N1,(39) N2 and (40) N3 respectively are to unify and assemble the novel instrument as well as serve the purpose of slider also. Three more centre pins (35) C4, (36)C5 & (37) C6 are for trisector links Ti & T2 along with locking knobs (41)N4, (42)N6 & (43)N6 respectively.
(H) Three vernier caliper locking screws (44)VS1, (45)VS2 & (46)VS3 are provided in the vernier caliper threaded holes (47)VH1, (48)VH2 & (49)VH3 respectively to lock the vernier caliper movements as well as to fix the required measurements in M1, M2 & M3 with locking.
(I) Four indicator locking screws (50) DS1,(51)DS2, (52)DS-3 & (53)DS4 are in the indicator's threaded holes (54)DH1, (55)DH2, (56)DH3 & (57)DH4 respectively to lock the movement of indicator as well as to fix the measurement of angles in the protractors P1, P2, P3 & P4 respectively
(J) Marker Block (58)‘R’ with vernier caliper including vernier jaw and centre pin with holder attachment to mark the lines, points, spots etc as per need. It helps to mark the lines/points in the centre of the slotted links and also for vernier caliper functions.
(K) An attachment of Trisector link cum lever (59)T1 with center pin hole (60)TH1 & (61)TH2 and Trisector slotted link (62) with centre pin hole (63)TH3, are provided with center pins C4, C5 & C6 to trisect and multiply an angle. Trisector link T1 is fitted in the center pins C4 & C5 and Trisector slotted link T2 with indicator D4 is fitted in the center pins C4, C5 & C6 for the purpose of trisector operations.
(L) Slotted paths, (64)SP1, (65) SP2, (66)SP3 & (67)SP4 are in the just middle of slotted links M1, M2, M3 & T2 and leg holes (68)LH1, (69)LH2, (70)LH3 & (71)LH4 are in the end of the slotted links with stands/legs (72)L1, (73)L2, (74)L3 & (75)L4 respectively.
(M) Two pairs of Plotter holes (76)PL1 & (77)PL2 and (78)PL3 & (79)PL4 are provided in both sides of the slotted link M2. Two pairs of Plotter holes (80)PL5 & (81)PL6 and (82)PL7 & (83)PL8 are provided in both sides of the slotted link M3. Plotter Pin set (84)PP1 & (85)PP2 and (86)PP3 & (87)PP4 is provided for M2 & M3 respectively for the purpose of trisector operations.
(N) The cylindrical and hallow center pins, with threaded holes in the sides of head portion (88)CH1,(89)CH2,(90)CH3,(91)CH4, (92)CH5 & (93)CH6 and holder screws (94)CS1, (95)CS2, (96)CS3, (97)CS4, (98)CS5 & (99)CS6, to hold the marker/pointer/pencil and other objects inserted in the hallow portion of centre pins, whenever required.

65. The instrument is multipurpose instrument for mathematical applications to the solutions of a triangle as a ready reckoner—with three slotted links—1(M1), 2(M2) & 3(M3) of inbuilt main measuring scales are performing as three sides of a triangle and three protractors—P1, P2 & P3—are performing as three vertices of a triangle to draw all types of triangles as required with all measurements of sides & angles, by using vernier calipers and indicators fractionally and accurately with other attachments.

66. The instrument as claimed in claim (64) where in the instrument is multipurpose instrument to draw all triangles—acute angled triangle, Right angled triangle, Obtuse angled triangle, Isosceles triangle, Equilateral triangle and scalene triangle with fractional and accurate measurements.

67. The instrument as claimed in claim (64) wherein the instrument is multipurpose instrument to draw a complete triangle, if two sides & one angle is available, with out performing the exercise of geometrical measurements and mathematical calculations for third side and two other angles, as a ready reckoner.

68. The instrument as claimed in claim (64) wherein the instrument is multipurpose instrument to draw a complete triangle, if two angles & one side is available, without performing the exercise of geometrical measurements & mathematical calculations for third vertex (angle) and two other remaining sides, as a ready reckoner.

69. The instrument as claimed in claim (64) wherein the instrument is multipurpose instrument to draw a complete triangle, if only three sides of a triangle are available with out performing the exercise of geometrical measurements and mathematical calculations for all three vertices/angles of a triangle, as a ready reckoner.

70. The instrument as claimed in claim (65) wherein the instrument is multipurpose instrument to find the measurements of sides and angles between the sides of all triangles—acute angled triangle, Right angled triangle, Obtuse angled triangle, Isosceles triangle, Equilateral triangle and scalene triangle, fractionally and accurately.

71. The instrument as claimed in claim (65) wherein the instrument is multipurpose instrument to find the measurements of third side and other two angles of a triangle fractionally and accurately as a ready reckoner, if two sides and one angle of said triangle is available—without performing the exercise of geometrical measurements and mathematical calculations.

72. The instrument as claimed in claim (65) wherein the instrument is multipurpose instrument to find the measurements of third angle and other two sides of a triangle fractionally and accurately as a ready reckoner, if two angles and one side of a triangle is available without performing the exercise of geometrical measurements and mathematical calculations.

73. The instrument as claimed in claim (65) wherein the instrument is multipurpose instrument to find the measurements of all three angles of a triangle fractionally and accurately as a ready reckoner, if only three sides of a triangle are available, with out performing the exercise of geometrical measurements and mathematical calculations, easily, quickly and with out any strain.

74. The instrument as claimed in the claim (65) wherein the instrument is multipurpose instrument usage for the purpose as a ready reckoner for triangle solutions to prove practically the “Pythagoras” theorem. i.e. a²+b²=c² “the area of the square on the hypotenuse (c) of a right-angled triangle is equal to the sum of the areas of the squares on the other two sides (a & b)” or c=√(a²+b²), i.e. “the hypotenuse (c) of a right-angled triangle is equal to square root of the sum of the squares on the other two sides (a & b)” can be proved with out performing the measurements & avoiding the exercise of mathematical calculations easily, quickly and with out any strain by knowing only two sides.

75. The instrument as claimed in the claim (65) wherein the instrument is multipurpose instrument uses as a ready reckoner for triangle solutions for “Pythagoras” theorem with immediate result without performing the exercise of geometrical measurements and mathematical calculations even in the conditions that only one side & one angle of the said right angled triangle is available.

76. The instrument as claimed in the claim (65) wherein the instrument is multipurpose instrument uses as a ready reckoner for triangle solutions for “Pythagoras” theorem with immediate result without performing the exercise of geometrical measurements and any mathematical calculations even in the conditions that only two sides of the said right angled triangle is available

77. The instrument as claimed in the claim (65), wherein the instrument is multipurpose instrument usage for the purpose as a ready reckoner for triangle to find the relationship between sides and angles accurately by using slotted links cum main measuring scales and protractors with vernier scales & indicators.

78. The instrument as claimed in the claim (65) wherein the instrument is multipurpose instrument usage for the purpose as a ready reckoner for triangle solutions; to find the height (altitude) of a triangle, by keeping one of the slotted links at ninety degrees from where the height is to be measured.

79. The instrument as claimed in claim (64) wherein the instrument is multipurpose instrument for the purpose of protractor, to draw an angle up to 180 degrees accurately up to the mark of fraction of degrees by using any two slotted links of 1/2/3 and a protractor with indicator.

80. The instrument as claimed in claim (65) wherein the instrument is multipurpose instrument for the purpose of protractors, to draw two angles at a time/simultaneously with different measurements accurately and fractionally to easy the process, by using all three slotted links cum main measuring scales 1,2, & 3 with two protractors 10 & 12.

81. The instrument as claimed in claim (65) wherein the instrument is multipurpose instrument for the purpose of protractors, to draw three angles of a triangle at a time/simultaneously with different measurements accurately and fractionally to easy the process, by using all three slotted links 1, 2 & 3 and three protractors 10, 11 & 12 with indicators.

82. The instrument as claimed in claim (65) wherein the instrument is multipurpose instrument for the purpose of protractors to measure the angles of industrial objects and other items accurately; including angular objects/goods/items can be measured by keeping those, between any two slotted links—1 & 2 or 2 & 3 or 1 & 3 and using protractor—10/11/12 with indicator—18/19/20 for fractional and accurate measurements of angles.

83. The instrument as claimed in claim (65) wherein the instrument is multipurpose instrument for the purpose of protractor to measure the angle up to 180 degrees fractionally and accurately.
